(19) United States
(12) Patent Application Publication
(10) Pub. No.: US 2006/0042366 A1
(43) Pub. Date: Mar. 2, 2006

(54) Pneumatic tyre comprising an indicator of excess temperature reached during use

(76) Inventors: Antonio Carrus, Cormano (IT); Chira Cipriani, Varese (IT); Antonio Zaopo, Milano (IT); Anna Paola Fioravanti, Monza (IT); Gloria Stucchi, Segrate (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/527,025

(22) PCT Filed: Sep. 20, 2002
(86) PCT No.: PCT/EP02/10622

§ 371 Date: Aug. 2, 2005

(51) Int. Cl. G01M 17/02

(52) U.S. Cl. 73/146

(57) ABSTRACT

A temperature indicator includes at least one reactive substance and at least one dye substance. The at least one reactive substance has a threshold temperature and the at least one dye substance has at least one characteristic peak in its absorption or emission spectrum. When an excess temperature is reached in the tire, the at least one reactive substance is heated above the threshold temperature and reacts with the at least one dye substance so as to modify the at least one characteristic peak. A related pneumatic tire includes at least one such temperature indicator.

The present invention relates to a pneumatic tyre comprising an indicator of excess temperature reached during use.

It is known in the art to provide a tyre having a temperature indicator.

For instance, DE 196 43 995 (in the name of Continental Aktiengesellschaft) discloses a tyre with a temperature indicator applied to at least one point on at least one sidewall. This indicator reversibly changes its appearance, in particular its color, on reaching or exceeding a specific temperature. The driver of a vehicle having tyres fitted with such temperature indicators will be made aware, for example on filling the tank or parking, as to whether one of the tyres is overheating. The indicator changes color again when the tyre cools down.

EP 1 184 210 (in the name of Nokian Tyres P.L.C.) relates to a vehicle tyre wherein at least a part is made of a material that varies in color with the temperature, so as to immediately indicate the outdoor and/or tyre temperature.

U.S. Pat. No. 5,962,778 (in the name of Compagnie Generale des Etablissements Michelin) refers to a device for monitoring stresses undergone by a tyre. Advantageously it is possible to use a heat-sensitive base product designed to change color after a local or general heating exceeding a predetermined reference value. This change is said to be permanent. No specific hint is provided on how such a device can be built.

According to the Applicant, tyre temperature detection is of particular importance in the so-called run flat tyres. These tyres are designed so as to be able to ensure, when deflated, safety run conditions for the vehicle for a prescribed number of kilometers without exceeding a predetermined speed (e.g. 50-80 km/h). The possibility of re-using a run flat tyre after rolling under deflation conditions can be evaluated upon a visual inspection of the tyre. However, a visual inspection sometimes cannot reveal damages undergone by the tyre during running in a deflated state.

In this respect, it should be taken into account that, when a tyre runs under undue conditions, for example with a reduced inflation pressure, its temperature may abnormally increase mainly because of severe bending stresses on sidewalls and carcass, and that excess temperature may cause damages, such as chemical degradation of rubber components, which eventually may cause tyre failure. Such damages can be hardly detected by visual inspection, but they can be very dangerous for driving safety.

Therefore, the Applicant has faced the problem of providing a tyre, particularly a run flat tyre, with a device that is able to irreversibly indicate that an excess temperature has been reached by the tyre during use, so as to give a warning to the user that the tyre may have suffered of damages as a consequence of an abnormal use, particularly of use in a deflated condition.

The Applicant has now found that the above problem can be solved by equipping the tyre with an Indicator comprising a reactive substance having a threshold temperature and a dye substance having at least a characteristic peak in its absorption or emission spectrum, so that when an excess temperature is reached in the tyre due to overheating during use, the reactive substance is heated above the threshold temperature and reacts with the dye substance so as to modify the absorption or emission spectrum of the dye substance. Therefore, a discolouring of the dye substance occurs which can be easily detected for instance by a visual Inspection of the tyre.

Therefore, according to a first aspect the present invention relates to a pneumatic tyre comprising at least a temperature indicator Including at least one reactive substance having a threshold temperature and at least one dye substance having at least a characteristic peak in its absorption or emission spectrum, so that when an excess temperature is reached in the tyre the at least one reactive substance is heated above the threshold temperature and reacts with the at least one dye substance so as to modify said characteristic peak of the at least one dye substance.

The reactive substance is selected to have a threshold temperature corresponding to the excess temperature that the tyre can reach when operating in undue conditions and that, when maintained for a given time, can cause damages to the tyre.

The tyre of the present invention can have at least two temperature indicators containing different reactive substances having different threshold temperatures, each corresponding to different levels of overheating of the tyre.

According to another embodiment of the invention, the tyre may have a plurality of temperature indicators placed in different positions of the tyre.

Applicant found that the temperature of a tyre when running increases in function of the distance from the equatorial plane of the tyre.

Therefore, by positioning temperature indicators according to the invention in axial sequence between the crown shoulder and the equatorial plane of the tyre, it is possible to check for how long time the tyre run in undue conditions generating overheating. Initially, overheating occurs in proximity of the crown shoulder, and a temperature indicator positioned in this tyre portion reacts first. Persisting undue running conditions, portions more and more in proximity of the equatorial plane of the tyre suffer overheating, and the temperature indicators positioned in those portion react accordingly.

In the present description and claims, with “dye substance” it is meant a substance having an absorption spectrum, i.e. the curve of radiant energy absorbed by the substance as a function of the energy incident upon it, containing at least one characteristic absorption peak in the region of wavelengths ranging from UV radiation to IR radiation, namely from 120 nm to 10 mm, preferably in the region of visible light, namely from 400 nm to 700 nm.

Alternatively, the dye substance can be a fluorescent substance emitting in the above said wavelength region so as to give a characteristic peak in its emission spectrum.

A change of the absorption or emission spectrum can be detected by common means, for example, by a visual inspection when the change in the absorption or emission spectrum occurs In the region of visible light, or by UV lamps, a spectrometer or a colorimeter.

Examples of dye substances are carbonyl dyes, such as anthraquinones and indigoids.

In the present description and claims, with “reactive substance having a threshold temperature” it is meant a substance which, when heated to a temperature equal to or higher than the threshold temperature, reacts with the dye substance so as to modify at least a characteristic peak of the absorption or emission spectrum of the latter.

Preferably, the reactive substance Is a radical initiator, such as a peroxide, preferably an organic peroxide, for example a benzoyl peroxide such as paramethyl benzoyl peroxide.

In particular, in the temperature indicator the molar ratio radical initiator dye substance is preferably of from about 50:1 to about 150:1, more preferably from about 90:1 to about 120:1.

Advantageously, the temperature indicator further comprises an opaque medium. In the present description and claims, with “opaque medium” it is meant a substance that has a high optical density. The opaque medium helps detection of the above change by hiding the dark colour of the tyre rubber and providing a light background for the dye substance.

The opaque medium is chemically inert with respect to the other components of the temperature Indicator. For example, it can be selected from titanium dioxide, calcium carbonate, silica, sodium sulfate, or mixtures thereof.

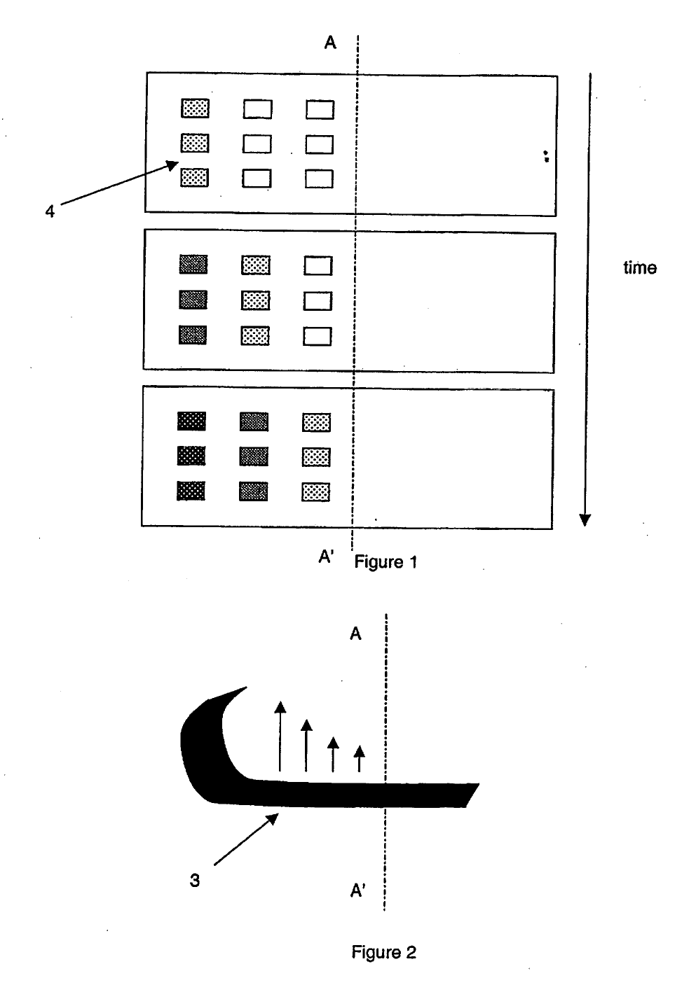

The temperature indicator is applied on the tyre after vulcanization of the tyre, to avoid premature reaction between the reactive substance and the dye substance. The temperature indicator can be applied on any position of the tyre surface, for instance on a sidewall or on the Inner liner, as shown in FIG. 1.

The application can be carried out by spraying or painting a solution or suspension including the various ingredients of the temperature indicator onto the surface of the tyre.

Alternatively, the temperature indicator can be previously applied on the surface of an adhesive substrate, which is then applied onto the tyre. In this way the application of the temperature indicator can be performed very quickly and easily by the user or by the tyre installer.

The temperature indicator according to the invention may further comprise a binding material. The binding material may be applied as a coating onto the temperature indicator, or it may be admixed with the other components of the temperature indicator. Said binding material is, for example, a cross-linkable material or a material with low temperature-vulcanizing or -polymerizing properties. For example, said binding material comprises 1,2-polybutadiene (for example, Lithene® AH), sulfur and, optionally, at least a vulcanization accelerator. Preferably, the vulcanization accelerator is an ultra-accelerator, i.e. an accelerator highly active even at relatively low temperatures, selected for example from: dithiocarbamates, thiurams, thiazoles, and mixtures thereof. Examples of ultra-accelerators which can be used according to the present invention are: zinc N-phenyl-N-ethyl-dithiocarbamate, zinc N,N-dimethyldithiocarbamate, zinc N,N-diethyl-dithiocarbamate, 2-mercapto-benzothiazole (MBT), 2-mercapto-benzothiazole disulphide (MBTS), N-cyclohexyl-2-benzothiazyl sulphenamide (CBS), 2-dicyclohexylbenzo-thiazyl sulphenamide (DCBS), N-tert-butyl-2-benzo-thiazyl sulphenamide (TBBS), N-morpholino-2-benzo-thiazyl sulphenamide (MBS), and N-tert-butyl-dithiobenzothiazole (TBSI).

At least one nitrogen-containing co-accelerator may be further added to the protective material, the co-accelerator being selected, for example, from N-cyclohexyl-N-ethylamine or diphenylguanidine (DPG), in an amount generally from 0.25 to 10 phr, and preferably from 0.5 to 8 phr.

Examples of materials which polymerize at low temperature are reactive monomers such as (C1-8)alkyl-cyano-acrylates, preferably ethyl-cyano acrylate.

In a second aspect, the present invention relates to a temperature indicator comprising at least one reactive substance having a threshold temperature and at least one dye substance having at least a characteristic peak in its absorption or emission spectrum, so that when an excess temperature is reached in the tyre the at least one reactive substance is heated above the threshold temperature and reacts with the at least one dye substance so as to modify said characteristic peak of the at least one dye substance.

The temperature Indicator of the present invention provides information not only about an overheating occurred to the tyre, but also about the duration of such overheating. The process yielding to the change of the characteristic peak in the absorbance spectrum profile of the dye substance occurs in two steps. The first step is the reaction of the reactive substance to the threshold temperature onset. Such a reaction is the limiting step of the overall process, as the modification of the reactive substance has to reach a certain extent to initiate the characteristic peak changing step.

For example, a peroxide (reactive substance) undergoes a thermo-induced homolytic dissociation yielding radicals at and above a predetermined threshold temperature. Said radicals act on a chromophore of the dye substance modifying its chemical structure, for example discoloring it.

The peroxide homolytic dissociation is the limiting step of the process. A certain period of time is necessary to make the amount of radicals sufficient to act on the chromophores and to cause their modification in a detectable way. The modification of the dye substance chromophore develops in time.

The temperature indicator of the invention provides information not only about the temperature reached by the tyre, but also if the harmful thermal status persisted for a period causing structural damages.

The invention will be further illustrated hereinafter with reference to the following examples and figures, wherein

FIG. 1 schematically illustrates the sequential reaction of a plurality of temperature indicators of the invention positioned on the inner liner in the crown portion, and

FIG. 2 shows the heat flux in a schematical partial cross-section of a tyre;

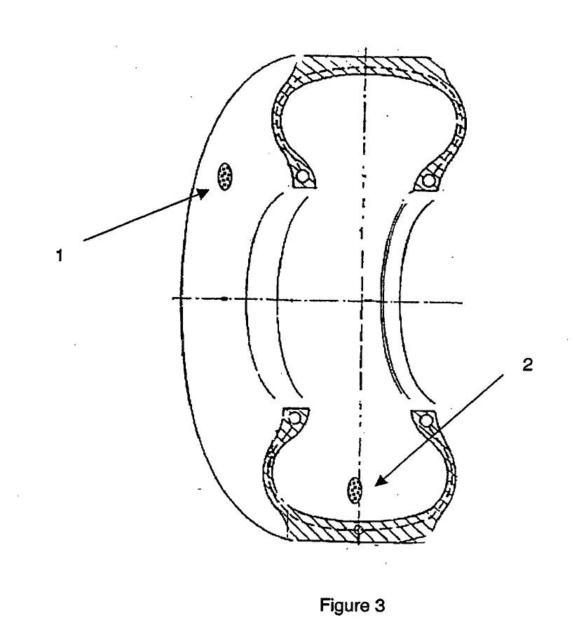

FIG. 3 illustrates a tyre of the invention provided with a temperature indicator on the inner liner (2) and, as an alternative or additional embodiment, on the sidewall (1).

FIG. 2 depicts the temperature of a crown portion (3) of a tyre when running. The height of the arrows rising from crown portion (3) is proportional to the heat flux developed. The temperature increases in function of the distance from the equatorial plane A-A′ of the tyre.

As from FIG. 1, temperature indicators (4) positioned nearer to the crown shoulder discolor first in time. As the tyre keeps on running in undue conditions, the discoloring progressively involves temperature indicators (4) nearer and nearer to the equatorial plane A-A′.

### EXAMPLE 1

Preparation of a Temperature Indicator

In a 100 ml flask, indigo (35 mg), titanium dioxide (180 mg) and chloroform (50 ml) were placed (Suspension A). The so obtained suspension was treated by ultrasonication at 46 Hz for 30 seconds at room temperature.

In a 250 ml flask, paramethyl benzoyl peroxide (25 g; PMBP, Peroxid Chemie GmbH, 50% by weight dispersion in silicone paste) and chloroform (250 ml) were placed (Solution B). The solution was treated by ultrasonication at 46 Hz for 20 minutes at room temperature.

5 parts in volume of Suspension A and 1 part in volume of Solution B were admixed, and the resulting mixture was treated by ultrasonication at 46 KHz for 30 seconds, thus yielding Suspension C.

Moreover, the following solutions were prepared:

Solution D
50 phr of polybutadiene-1,2 (Lithene® AH, Dow Corning)
3.5 phr of sulfur
100 ml of n-heptane.

Solution E
50 phr of polybutadiene-1,2 (Lithene® AH)
3 phr of Vulkacit® P extra N (Bayer)
0.5 phr of Vulkacit® Mercapto (Bayer)
2 phr of cyclohexy-ethyl-amine (Sigma Aldrich)
100 ml of n-heptane

### EXAMPLE 2

Discoloring Test

Suspension C as from Example 1 was sprayed on the inner liner of a radial section of a run flat tyre, in a crown position. The solvent was left to evaporate. The tyre section was put into an oven and heated up to 130° C. After 12 minutes, the tyre section reached 130° C. (corresponding to the threshold temperature of the paramethyl benzoyl peroxide). For 18 minutes no substantial changes have been observed in the temperature indicator. In the subsequent 5 minutes a discoloring from light blue to yellow-brown was observed.

### EXAMPLE 3

Preparation of a Temperature Display with Protecting Material (Suspension F) and Discoloring Test Thereof

Suspension C (1 ml), Solution D (0.5 ml) and Solution E (0.5 ml) were admixed to yield Suspension F. Said suspension was tested following the same procedure set forth in Example 3. Analogous results were obtained.

### EXAMPLE 4

Preparation of a Temperature Display with Protecting Material and Discoloring Test Thereof

Suspension C (20 ml) as from Example 1 was sprayed on the inner liner of a run flat tyre radial section, in crown position. The solvent was left to evaporate. Ethyl cyano acrylate (0.5 ml) was dropped on the surface of the resulting layer of suspension C. After few seconds, the section was put in an oven and heated up to 130° C. After 12 minutes, the tyre section reached 130° C. (corresponding to the threshold temperature of the paramethyl benzoyl peroxide). For 18 minutes no substantial changes have been observed in the temperature indicator. In the subsequent 5 minutes a discoloring from light blue to yellow-brown was observed.

### EXAMPLE 5

Test on the Road

Suspension C as from Example 1 was sprayed on the inner liner of four run flat tyres, in crown position. The solvent was left to evaporate

The herein below mentioned tyres 1, 2, and 3 were mounted, in turn, on the right front position of a passenger car, while tyre 4 was in the left front position in every test.

Tyre 1 was made to run deflated at a constant speed of 80 Km/h, for 30 Km.

Tyre 2 was made to run deflated at a constant speed of 80 Km/h, for 60 Km.

Tyre 3 was made to run deflated at a constant speed of 80 Km/h, for 150 Km.

Tyre 4 was made to run inflated (cold pressure=2.2 bar) at a constant speed of 80 Km/h, for 240 Km, and at a variable speed (max 120 km/h) for at least 150 km.

At the end of the test the temperature display on tyres 1, 2 and 3 showed a visible discoloring from blue to brown. The temperature display on reference tyre 4 did not show discoloring.

### EXAMPLE 6

Test on the Road

Suspension F as from Example 4 was sprayed on the inner liner of four run flat tyre, in crown position. The solvent was left to evaporate

The herein below mentioned tyres 1, 2, and 3 were mounted, in turn, on the right front position, while tyre 4 was in the left front position in every test.

Tyre 1 was made to run deflated at a constant speed of 80 Km/h, for 30 Km.

Tyre 2 was made to run deflated at a constant speed of 80 Km/h, for 60 Km.

Tyre 3 was made to run deflated at a constant speed of 80 Km/h, for 150 Km.

Tyre 4 was made to run inflated (cold pressure=2.2 bar) at a constant speed of 80 Km/h, for 240 Km, and at a variable speed (max 120 km/h) for at least 150 km.

At the end of the test the temperature display on tyres 1, 2 and 3 showed a visible discoloring from blue to brown. The temperature display on reference tyre 4 did not show discoloring.

1-18. (canceled)

19. A pneumatic tyre, comprising:
at least one temperature indicator;
wherein the at least one temperature indicator comprises:
at least one reactive substance; and
at least one dye substance;
wherein the at least one reactive substance has a threshold temperature,
wherein the at least one dye substance has at least one characteristic peak in its absorption or emission spectrum,
wherein, when an excess temperature is reached in the tyre, the at least one reactive substance is heated above the threshold temperature and reacts with the at least one dye substance so as to modify the at least one characteristic peak.

20. The pneumatic tyre of claim 19, comprising:
at least two temperature indicators.

21. The pneumatic tyre of claim 20, wherein the at least two temperature indicators comprise different reactive substances with different threshold temperatures.

22. The pneumatic tyre of claim 20, wherein the at least two temperature indicators are positioned in axial sequence between a crown shoulder and an equatorial plane of the tyre.

23. The pneumatic tyre of claim 19, wherein the at least one dye substance comprises a carbonyl dye.

24. The pneumatic tyre of claim 19, wherein the at least one reactive substance comprises a radical initiator.

25. The pneumatic tyre of claim 24, wherein the radical initiator is a peroxide.

26. The pneumatic tyre of claim 24, wherein the radical initiator is paramethyl benzoyl peroxide.

27. The pneumatic tyre of claim 24, wherein a molar ratio of the radical initiator to the at least one dye substance is greater than or equal to about 50:1 and less than or equal to about 150:1.

28. The pneumatic tyre of claim 24, wherein a molar ratio of the radical initiator to the at least one dye substance is greater than or equal to about 90:1 and less than or equal to about 120:1.

29. The pneumatic tyre of claim 19, wherein the at least one temperature indicator comprises an opaque medium.

30. The pneumatic tyre of claim 29, wherein the opaque medium comprises one or more of titanium dioxide, calcium carbonate, silica, and sodium sulfate.

31. The pneumatic tyre of claim 19, wherein the at least one temperature indicator comprises a binding material.

32. The pneumatic tyre of claim 31, wherein the binding material is a cross-linkable material.

33. The pneumatic tyre of claim 31, wherein the binding material comprises low-temperature-vulcanizing properties.

34. The pneumatic tyre of claim 31, wherein the binding material comprises low-temperature-polymerizing properties.

35. The pneumatic tyre of claim 31, wherein the binding material comprises (C1-8)alkyl-cyano-acrylates.

36. The pneumatic tyre of claim 19, wherein the at least one temperature indicator is coated by a binding material.

37. The pneumatic tyre of claim 36, wherein the binding material is a cross-linkable material.

38. The pneumatic tyre of claim 36, wherein the binding material comprises low-temperature-vulcanizing properties.

39. The pneumatic tyre of claim 36, wherein the binding material comprises low-temperature-polymerizing properties.

40. The pneumatic tyre of claim 36, wherein the binding material comprises (C1-8)alkyl-cyano-acrylates.

41. The pneumatic tyre of claim 19, wherein the at least one temperature indicator is applied on a surface of an adhesive substrate, and
wherein the adhesive substrate is then applied onto the tyre.

42. A temperature indicator, comprising:
at least one reactive substance; and
at least one dye substance;
wherein the at least one reactive substance has a threshold temperature,
wherein the at least one dye substance has at least one characteristic peak in its absorption or emission spectrum,
wherein, when an excess temperature is reached in the tyre, the at least one reactive substance is heated above the threshold temperature and reacts with the at least one dye substance so as to modify the at least one characteristic peak.
